(19) United States
(12) Patent Application Publication
(10) Pub. No.: US 2005/0259274 A1
(43) Pub. Date: Nov. 24, 2005

(54) Method and apparatus for measuring displacement

(76) Inventors: Kuo-Chin Chuang, Taipei City (TW); Wang-Lin Liu, Taichung City (TW); Tien-Kan Chung, Tao-Yuan Hsien (TW)

Correspondence Address: BAKER & DANIELS LLP;111 E. WAYNE STREET, SUITE 800, FORT WAYNE, IN, 46802, US

(21) Appl. No.: 10/852,040

(22) Filed: May 24, 2004

(51) Int. Cl. G01B 11/14

(52) U.S. Cl. 356/616; 356/369

(57) ABSTRACT

In a method and apparatus for measuring displacement, an optical modulator includes a magneto-optical recording layer recorded with a plurality of light-reflecting graduation regions. The light-reflecting graduation regions include alternately disposed first and second graduations. The first graduations have a first magnetization direction. The second graduations have a second magnetization direction different from the first magnetization direction. A light source is operable so as to generate a light beam that is incident on the magneto-optical recording layer. The optical modulator is movable relative to the light source such that the light beam is reflected in sequence by consecutive ones of the light-reflecting graduation regions recorded on the magneto-optical recording layer. An analyzing module analyzes changes in polarization characteristics of the light beam reflected from the magneto-optical recording layer to determine extent of displacement of the optical modulator relative to the light source.

### BACKGROUND OF THE INVENTION

1. Field of the Invention

The invention relates to a method and apparatus for measuring displacement, more particularly to a method and apparatus for measuring displacement using an optical modulator that is capable of changing polarization characteristics of an incident light beam.

2. Description of the Related Art

Referring to FIG. 1, a conventional linear scale suitable for linear measurements is shown to include a movable main scale 1, a stationary index scale 2, and a photo-detecting module 3. The main and index scales 1, 2 are formed with a series of slotted graduations 11, 21, such as by chemical etching. The photo-detecting module 3 includes a phototransistor unit 31, a detecting unit 32 coupled to the phototransistor unit 31, and a calculating unit 33 coupled to the detecting unit 32.

In use, light from a light emitting diode (LED) unit 4 passes through the slotted graduations 11, 21 of the main and index scales 1, 2. When the main scale 1 moves relative to the index scale 2, an interference output is generated. The interference output is received by the phototransistor unit 31, and is processed by the detecting unit 32 and the calculating unit 33 to result in a displacement output corresponding to the extent of linear displacement of the main scale 1 relative to the index scale 2.

Since the graduations 11, 21 formed in the main and index scales 1, 2 are fixed, the resolution of the linear scale is fixed and cannot be varied to suit a wider range of applications.

U.S. Pat. Nos. 4,733,968, 4,988,864, 5,079,418, 5,120,132, 5,500,734, and 5,574,560 disclose various types of optical measuring systems that employ grating/grid elements or deflection elements for measuring displacement. However, the techniques proposed therein are relatively complicated and are costly to implement.

### SUMMARY OF THE INVENTION

Therefore, the object of the present invention is to provide a method and apparatus for measuring displacement using an optical modulator so as to overcome the aforesaid drawbacks of the prior art.

According to one aspect of the invention, a method of measuring displacement comprises:
providing an optical modulator that includes a magneto-optical recording layer recorded with a plurality of light-reflecting graduation regions, the light-reflecting graduation regions including alternately disposed first and second graduations, the first graduations having a first magnetization direction, the second graduations having a second magnetization direction different from the first magnetization direction;
activating a light source to generate a light beam that is incident on the magneto-optical recording layer;
moving the optical modulator relative to the light source such that the light beam is reflected in sequence by consecutive ones of the light-reflecting graduation regions recorded on the magneto-optical recording layer; and
analyzing changes in polarization characteristics of the light beam reflected from the magneto-optical recording layer to determine extent of displacement of the optical modulator relative to the light source.

According to another aspect of the invention, an apparatus for measuring displacement comprises:
an optical modulator including a magneto-optical recording layer recorded with a plurality of light-reflecting graduation regions, the light-reflecting graduation regions including alternately disposed first and second graduations, the first graduations having a first magnetization direction, the second graduations having a second magnetization direction different from the first magnetization direction;
a light source operable so as to generate a light beam that is incident on the magneto-optical recording layer;
the optical modulator being movable relative to the light source such that the light beam is reflected in sequence by consecutive ones of the light-reflecting graduation regions recorded on the magneto-optical recording layer; and
an analyzing module for analyzing changes in polarization characteristics of the light beam reflected from the magneto-optical recording layer to determine extent of displacement of the optical modulator relative to the light source.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a conventional linear scale;

FIG. 2 illustrates the preferred embodiment of an apparatus for measuring displacement according to the present invention;

FIG. 3 is a fragmentary schematic side view of an optical modulator used in the preferred embodiment;

FIG. 4 illustrates light-reflecting graduation regions on a magneto-optical recording layer of the optical modulator of FIG. 3;

FIG. 5 illustrates how graduations are recorded on the optical modulator of FIG. 3; and

FIG. 6 illustrates a light source used in the apparatus of the preferred embodiment.

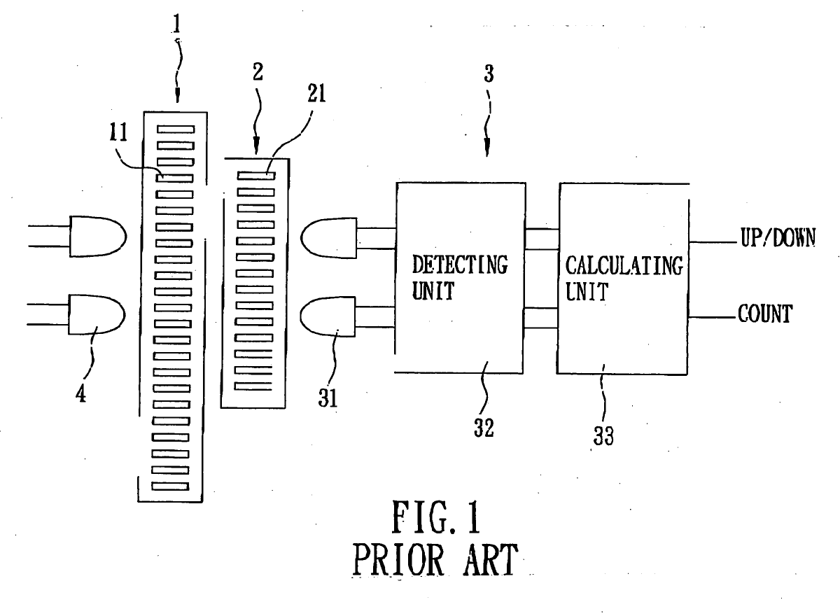

### DETAILED DESCRIPTION OF THE PREFERRED EMBODIMENT

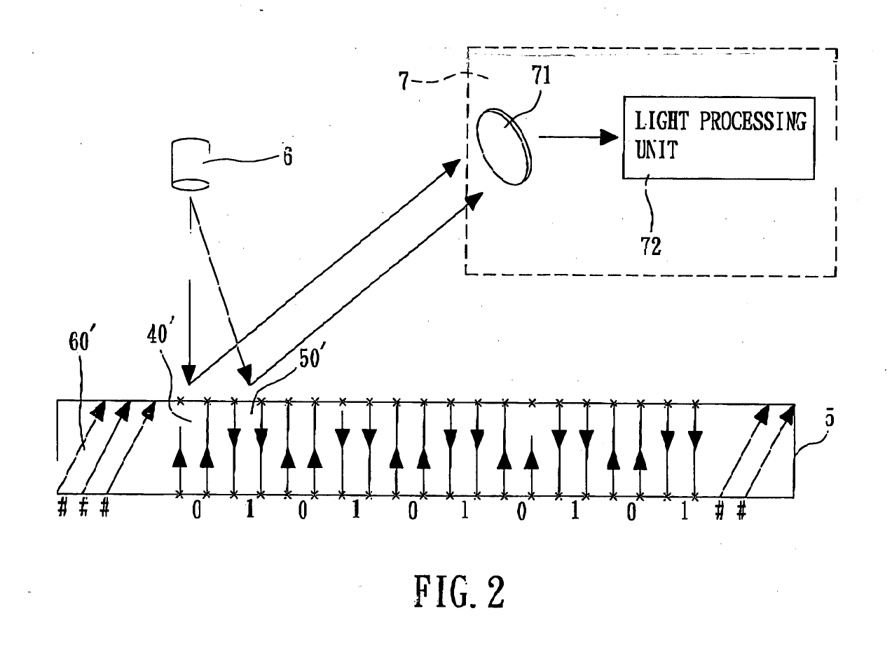

Referring to FIGS. 2 to 6, the preferred embodiment of an apparatus for measuring displacement according to the present invention is shown to comprise an optical modulator 5, a light source 6, and an analyzing module 7.

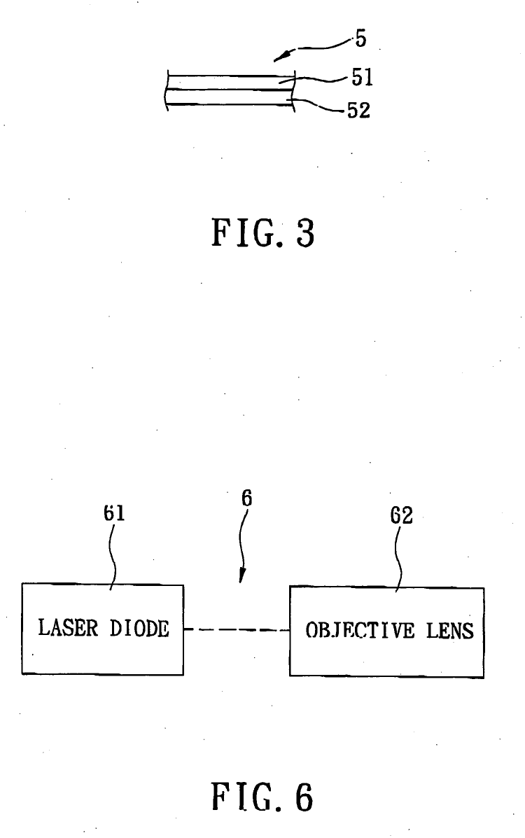

As shown in FIG. 3, the optical modulator 5 includes a substrate 52 and a magneto-optical recording layer 51 formed on the substrate 52. In this embodiment, the magneto-optical recording layer 51 is a conventional read-write layer having rewritable characteristics. The read-write layer is one of a cobalt-platinum and cobalt-palladium multi-layer stack. Details pertinent to the formation and characteristics of the read-write layer can be found in various literatures, such as U.S. Pat. No. 6,497,799, the entire disclosure of which is incorporated herein by reference.

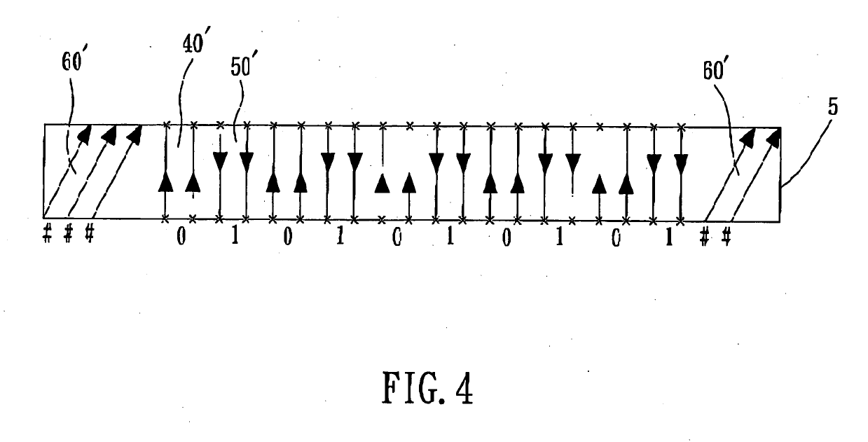

As shown in FIG. 4, the magneto-optical recording layer 51 is recorded with a plurality of light-reflecting graduation regions. The light-reflecting graduation regions include alternately disposed first and second graduations 40′, 50′. The first graduations 40′ have a first magnetization direction (indicated as reference numeral “0” in the drawings). The second graduations 50′ have a second magnetization direction (indicated as reference numeral “1” in the drawings) different from the first magnetization direction.

In this embodiment, the light-reflecting graduation regions further include third graduations 60′ having a third magnetization direction (indicated as reference numeral “#” in the drawings) different from the first and second magnetization directions. Adjacent ones of the third graduations 60′ have a set of the alternately disposed first and second graduations 40′, 50′ disposed therebetween.

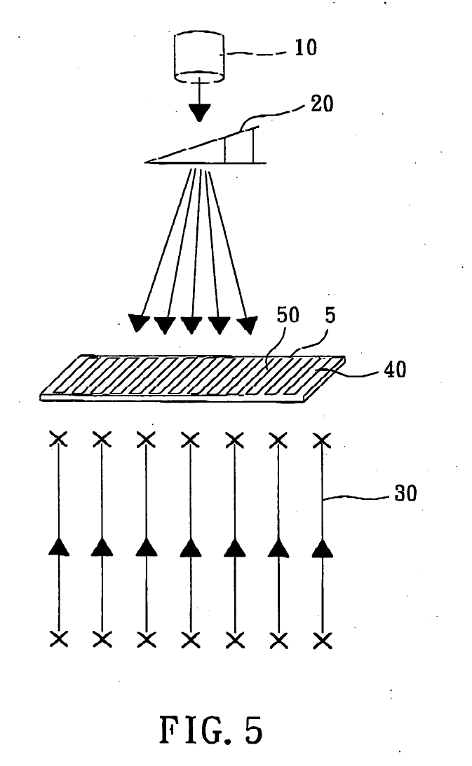

Referring to FIGS. 3 and 5, the first graduations 40′ are recorded simultaneously on the magneto-optical recording layer 51 through a first Curie point recording process. Particularly, a first magnetic field 30 perpendicular to the magneto-optical recording layer 51 is applied while intended locations 40 of the first graduations 40′ on the magneto-optical recording layer 51 are heated to above the Curie temperature via a first interference pattern that is generated by passing light, such as that generated by a laser diode 10, through an air wedge 20.

The second graduations 50′ are recorded simultaneously on the magneto-optical recording layer 51 through a second Curie point recording process that is similar to the first Curie point recording process. Particularly, a second magnetic field (not shown) perpendicular to the magneto-optical recording layer 51 is applied while intended locations 50 of the second graduations 50′ on the magneto-optical recording layer 51 are heated to above the Curie temperature via a second interference pattern that is generated by passing light through the air wedge 20.

The third graduations 60′ are recorded simultaneously on the magneto-optical recording layer 51 through a third Curie point recording process. Particularly, a third magnetic field (not shown) perpendicular to the magneto-optical recording layer 51 is applied while intended locations of the third graduations 60′ on the magneto-optical recording layer 51 are heated to above the Curie temperature. The third graduations 60′ can be used to indicate advancing or reversing movement, and as a reference when restoring the apparatus to an initial state.

The light source 6 is operable so as to generate a light beam that is incident on the magneto-optical recording layer 51. In this embodiment, the light beam generated by the light source 6 is a linearly polarized light beam, and the light source 6 includes a laser diode 61 and an objective lens 62 that receives light from the laser diode 61 and from which the linearly polarized light beam is obtained, as best shown in FIG. 6.

In use, the optical modulator 5 is moved relative to the light source 6 such that the linearly polarized light beam from the light source 6 is reflected in sequence by consecutive ones of the recorded graduations 40′, 50′, 60′ on the magneto-optical recording layer 51 of the optical modulator 5, as best shown in FIG. 2. In this embodiment, the optical modulator 5 is linearly displaced relative to the light source 6. Due to the so-called magnetic Kerr effect, the plane of polarization of the reflected light beam is rotated by an angle corresponding to the magnetization direction at the point of reflection on the magneto-optical recording layer 51. In this embodiment, the light beam reflected from the magneto-optical recording layer 51 is an elliptically polarized light beam having a major axis that is horizontal, vertical or at a 45° degree angle, depending on whether the point of reflection is at the first, second or third graduations 40′, 50′, 60′.

The analyzing module 7, which includes an analyzer 71 and a light processing unit 72, receives the reflected light beam from the optical modulator 5, and analyzes changes in the polarization characteristics of the reflected light beam to determine the extent of displacement of the optical modulator 5 relative to the light source 6. The analyzing module 7 is of the type commonly found in conventional magneto-optical disc reproduction devices (see, for example, U.S. Pat. No. 5,528,575). Since the particular construction of the analyzing module 7 is known in the art and is not pertinent to the claimed invention, a detailed description of the same will be dispensed with herein for the sake of brevity.

Assuming that the magnetization directions of the first, second and third graduations 40′, 50′, 60′ are 0, 1 and #, respectively, the analyzing module 7 can analyze the reflected light beam from the optical modulator 5 to result in the following detected sequence of magnetization directions: #.#.#.0.1.0.1.0.1.0.1.0.1.#.#. Particularly: consecutive “0” and “1” indicate one unit displacement; #.#.0.1 indicate advancing movement; #.#.1.0 indicate reversing movement; and #.#.# indicate restoration to the initial state.

It has thus been shown that the analyzing module 7 can indeed determine the extent of displacement of the optical modulator 5 relative to the light source 6 by analyzing the changes in the polarization characteristics of the reflected light beam from the optical modulator 5.

In the present invention, measurement of displacement is conducted using an optical modulator having light-reflecting graduations 40′, 50′, 60′ that are recorded on a magneto-optical recording layer 51. In view of the rewritable characteristics of the magneto-optical recording layer 51, the resolution of the optical modulator 5 may be varied to suit a wide range of applications.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method of measuring displacement, comprising:
providing an optical modulator that includes a magneto-optical recording layer recorded with a plurality of light-reflecting graduation regions, the light-reflecting graduation regions including alternately disposed first and second graduations, the first graduations having a first magnetization direction, the second graduations having a second magnetization direction different from the first magnetization direction;
activating a light source to generate a light beam that is incident on the magneto-optical recording layer;
moving the optical modulator relative to the light source such that the light beam is reflected in sequence by consecutive ones of the light-reflecting graduation regions recorded on the magneto-optical recording layer; and
analyzing changes in polarization characteristics of the light beam reflected from the magneto-optical recording layer to determine extent of displacement of the optical modulator relative to the light source.

2. The method as claimed in claim 1, wherein the magneto-optical recording layer is a read-write layer.

3. The method as claimed in claim 2, wherein the read-write layer is one of a cobalt-platinum and cobalt-palladium multi-layer stack.

4. The method as claimed in claim 1, wherein the light-reflecting graduation regions further include third graduations having a third magnetization direction different from the first and second magnetization directions, adjacent ones of the third graduations having a set of the alternately disposed first and second graduations disposed therebetween.

5. The method as claimed in claim 1, wherein the light beam generated by the light source is a linearly polarized light beam.

6. The method as claimed in claim 1, wherein the optical modulator is linearly displaced relative to the light source.

7. An apparatus for measuring displacement, comprising:
an optical modulator including a magneto-optical recording layer recorded with a plurality of light-reflecting graduation regions, said light-reflecting graduation regions including alternately disposed first and second graduations, said first graduations having a first magnetization direction, said second graduations having a second magnetization direction different from the first magnetization direction;
a light source operable so as to generate a light beam that is incident on said magneto-optical recording layer;
said optical modulator being movable relative to said light source such that the light beam is reflected in sequence by consecutive ones of said light-reflecting graduation regions recorded on said magneto-optical recording layer; and
an analyzing module for analyzing changes in polarization characteristics of the light beam reflected from said magneto-optical recording layer to determine extent of displacement of said optical modulator relative to said light source.

8. The apparatus as claimed in claim 7, wherein said magneto-optical recording layer is a read-write layer.

9. The apparatus as claimed in claim 8, wherein said read-write layer is one of a cobalt-platinum and cobalt-palladium multi-layer stack.

10. The apparatus as claimed in claim 7, wherein said light-reflecting graduation regions further include third graduations having a third magnetization direction different from the first and second magnetization directions, adjacent ones of said third graduations having a set of said alternately disposed first and second graduations disposed therebetween.

11. The apparatus as claimed in claim 7, wherein:
said first graduations are recorded simultaneously on said magneto-optical recording layer through a first Curie point recording process, in which a first magnetic field perpendicular to said magneto-optical recording layer is applied while intended locations of said first graduations on said magneto-optical recording layer are heated to above the Curie temperature via a first interference pattern that is generated bypassing light through an air wedge; and
said second graduations are recorded simultaneously on said magneto-optical recording layer through a second Curie point recording process, in which a second magnetic field perpendicular to said magneto-optical recording layer is applied while intended locations of said second graduations on said magneto-optical recording layer are heated to above the Curie temperature via a second interference pattern that is generated by passing light through the air wedge.

12. The apparatus as claimed in claim 7, wherein the light beam generated by said light source is a linearly polarized light beam, and said light source includes a laser diode and an objective lens that receives light from said laser diode and from which the linearly polarized light beam is obtained.

13. The apparatus as claimed in claim 7, wherein said optical modulator is linearly displaced relative to said light source.
